(19) United States
(12) Patent Application Publication
(10) Pub. No.: US 2010/0117546 A1
(43) Pub. Date: May 13, 2010

(54) LED LIGHT-EMITTING DEVICE

(75) Inventor: Ching-Chieh Cho, Changhua City (TW)

Correspondence Address: RABIN & Berdo, PC, 1101 14TH STREET, NW, SUITE 500, WASHINGTON, DC, 20005, US

(73) Assignee: Stone Tse Hung LIU, Cerritos, CA (US)

(21) Appl. No.: 12/267,855

(22) Filed: Nov. 10, 2008

(51) Int. Cl. H05B 37/02; F21V 21/00

(52) U.S. Cl. 315/200 R; 362/382

(57) ABSTRACT

The present invention relates to a LED light-emitting device comprising a substrate, at least one LED bulb and a rectifier assembly. The substrate comprises a flexible substrate. The flexible substrate comprises at least one pair of conductors. The conductors can be arranged straight or curved. The at least one LED bulb detachably connects to the conductors. The rectifier assembly comprises an electromagnetic interference (EMI) filter, a rectifier and a pulse width modulation (PWM) controller that stabilizes current flowing through the LED light-emitting device.

### FIELD OF THE INVENTION

The invention is an LED (light-emitting diode) light-emitting device, more particularly, an LED light-emitting device that has patterns that can be adjusted by users and has LED bulbs that can be replaced conveniently without securing power to the LED light-emitting device and causing current fluctuations that affect illumination from other bulbs in the LED light-emitting device.

### BACKGROUND OF THE INVENTION

Billboards are erected in conspicuous places so stores attract consumers' attention. Modern billboards often use light-emitting devices to show important words or patterns to improve advertising efficiency, especially at night. Conventional light-emitting devices are fluorescent lamps, neon lamps or multiple incandescent bulbs.

LED light-emitting devices have begun to replace conventional light-emitting devices because less power is consumed and less heat is generated, and the LED light-emitting devices can be controlled by a computer program and arranged in arrays of different configurations to form patterns or words. A conventional LED light-emitting device comprises a controller and multiple LED bulbs. The LED bulbs are arranged in adjacent rows, and each LED bulb is connected to the controller by a wire. Furthermore each row may be a modular unit. If an LED bulb in the modular unit breaks, the entire modular unit must be replaced, or a technician must repair or replace the broken LED bulb that will increase cost.

Furthermore, the LED bulbs must be mounted at specific locations in the modular units to present a desired pattern. If the pattern needs to be changed, the LED light-emitting supplier must redesign placement of the LED bulbs and rearrange the LED bulbs of the LED light-emitting device.

The LED light-emitting device is also inconvenient to move. Billboards with LED light-emitting devices are usually large and could be bumped and damaged when being transported.

### SUMMARY OF THE INVENTION

The main objective of the present invention is to provide an LED light-emitting device that changed easily and will not flicker when LEDs are changed.

The present invention relates to a LED light-emitting device comprising a substrate, at least one LED bulb and a rectifier assembly. The substrate comprises a flexible substrate. The flexible substrate comprises at least one pair of conductors. The conductors can be arranged straight or curved. The at least one LED bulb detachably connects to the conductors. The rectifier assembly comprises an electromagnetic interference (EMI) filter, a rectifier and a pulse width modulation (PWM) controller that stabilizes current flowing through the LED light-emitting device.

### BRIEF DESCRIPTION OF THE DRAWINGS

FIG. 1 is a side view in partial section of a first embodiment of a light-emitting diode (LED) light emitting device in accordance with the present invention.

FIG. 2 is a block diagram of a current regulator.

FIG. 3 is a side view in partial section of a second embodiment of a LED light emitting device in accordance with the present invention.

FIG. 4 is a cross sectional perspective view of a third embodiment of a LED light emitting device in accordance with the present invention.

FIG. 5 is a side view in partial section of a forth embodiment of a LED light emitting device in accordance with the present invention.

FIG. 6 is a side view in partial section of a fifth embodiment of a LED light emitting device in accordance with the present invention.

FIG. 7 is a side view in partial section of a sixth embodiment of a LED light emitting device in accordance with the present invention.

FIG. 8 is an operational perspective view of an LED light-emitting device in FIGS. 1 and 3 to 7 connected to and mounted on a decorative snowflake.

FIG. 9 is a partially exploded operational perspective view of a light-emitting plate of the LED light-emitting device in FIGS. 1 and 3 to 7.

### DESCRIPTION OF THE PREFERRED EMBODIMENT

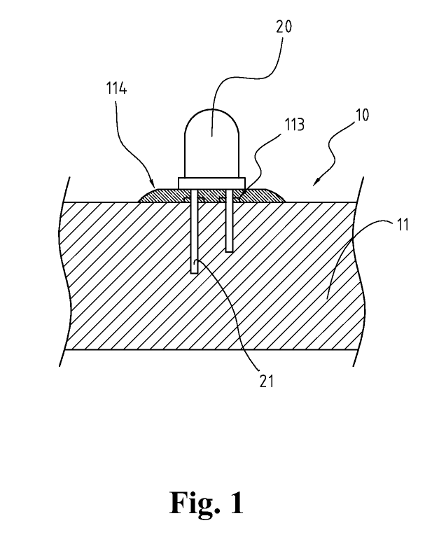

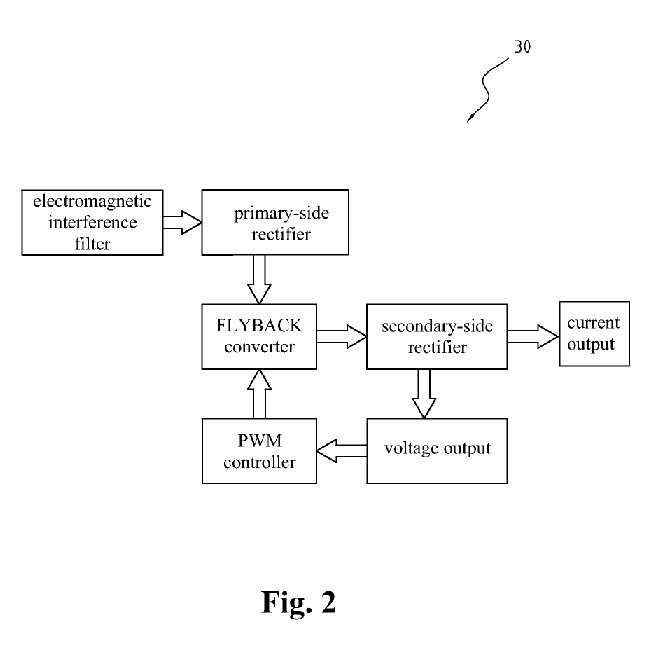

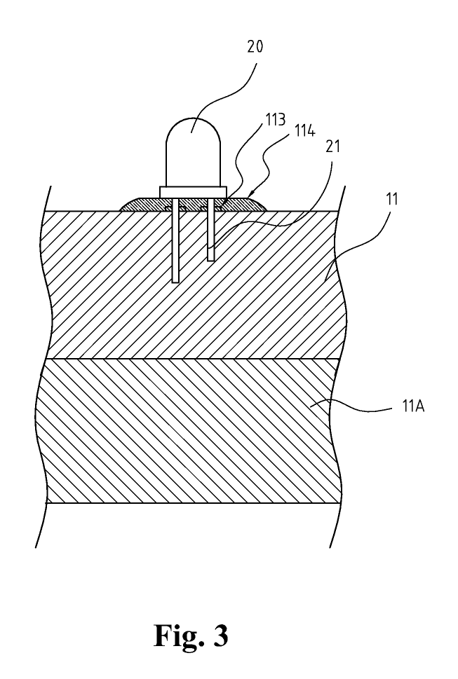

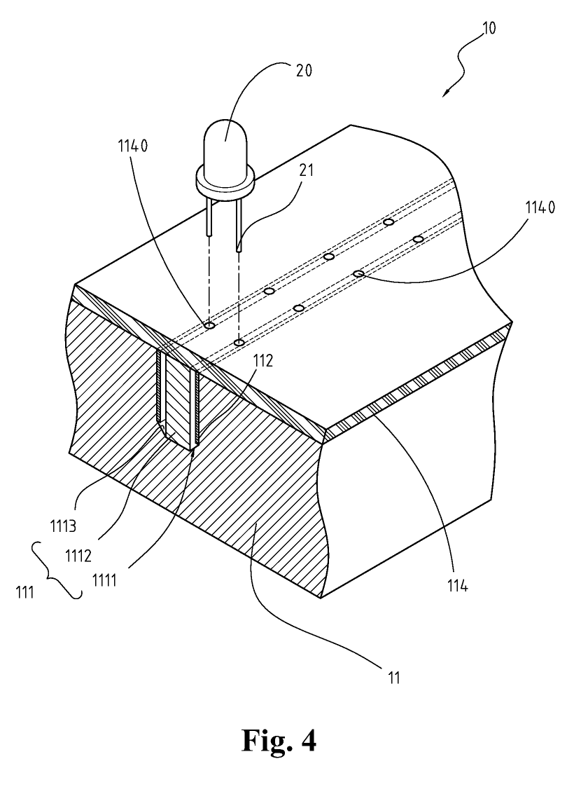

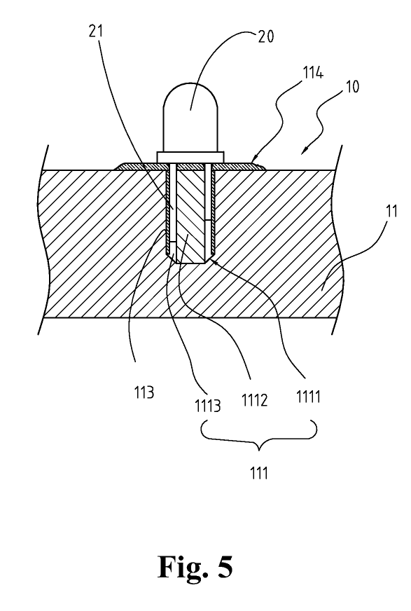

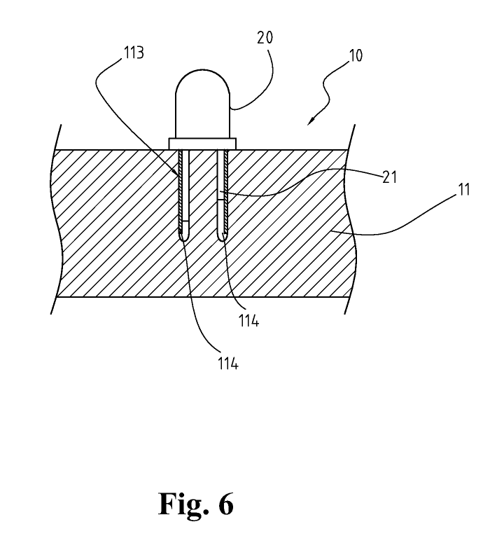

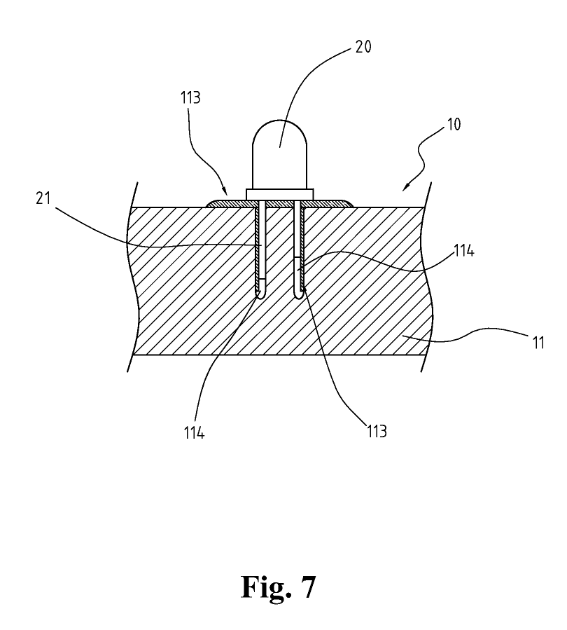

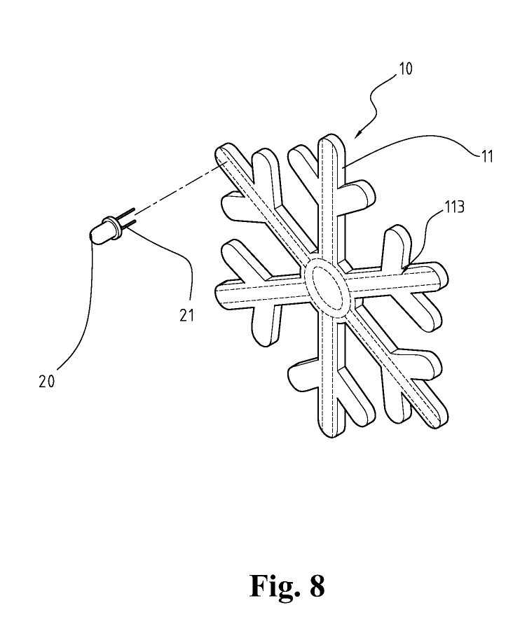

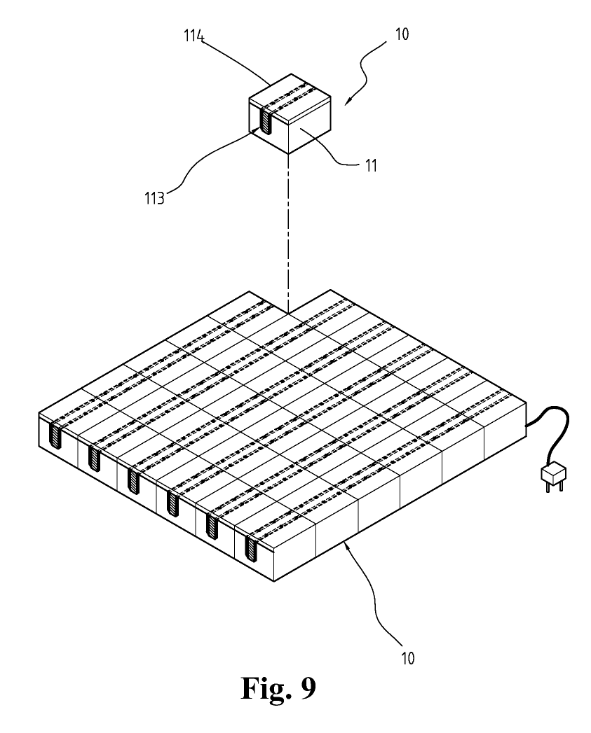

With reference to FIGS. 1 to 9, the LED light-emitting device in accordance with the present invention comprises a substrate (10), at least one LED bulb (20) and a rectifier assembly (30).

The substrate (10) comprises a flexible substrate (11) and an optional stiff substrate (11A).

The flexible substrate (11) has an outer surface, an inner surface and at least one optional groove assembly (111) or optional pair of grooves (112), may be multiple modules that connect to each other, may be foamed plastic, rubber or high-density foam and comprises at least one pair of conductors (113) and an optional waterproof coating (114).

Each optional groove assembly (111) comprises a groove (1111) and a longitudinal plug (1112). The groove (1111) is formed in the outer surface of the flexible substrate (11), may be straight or curved and has two outer sidewalls perpendicular to the outer surface. The longitudinal plug (1112) is mounted in the groove (1111), is slightly narrower than the groove and forms two corresponding gaps (1113).

Each optional pair of grooves (112) comprises two narrow grooves. The narrow grooves are formed in the outer surface of the flexible substrate (11), may be straight or curved and have two outer sidewalls perpendicular to the outer surface.

The conductors (113) may be mounted on the outer surface of the flexible substrate (11) or respectively on the outer sidewalls of each groove assembly or pair of corresponding narrow grooves, can be straight or curved and are metallic strips.

The waterproof coating (114) may be an acrylic sheet or a gel-like encapsulant layer, is mounted on the outer surface of the flexible substrate (11) over the at least one pair of conductors (113), may cover the entire outer surface and has at least one pair of through holes (1140). The through holes (1140) align respectively with all or part of the conductors (113). The stiff substrate (11A) may be wood, metal or plastic and is mounted against the inner surface of the flexible substrate (10).

The at least one LED bulb (20) is replaceable and has two prongs (21). The prongs (21) are mounted detachably respectively in contact with the conductors (113).

The rectifier assembly (30) comprises an electromagnetic interference (EMI) filter, a rectifier and a pulse width modulation (PWM) controller.

The EMI filter eliminates any noise attempting to enter from an external power source.

The adapter converts alternating current (AC) to direct current (DC) and has a primary-side and a secondary-side. The primary-side converts AC to DC through a primary-side rectifier filter. The secondary-side receives the primary-side rectifier current and converts the primary-side rectifier current to DC through a secondary rectifier. The secondary rectifier current is converted to an output DC current by a FLYBACK converter that maintains and supplies power with stable current and voltage.

The PWM controller controls the output DC current.

What is claimed is:

1. A LED light-emitting device comprising
a substrate comprising
a flexible substrate further comprising at least one pair of conductors;
at least one LED bulb being replaceable and having two prongs being stiffer than and being mounted detachably respectively in contact with the conductors; and
a rectifier assembly comprising
an electromagnetic interference (EMI) filter to eliminate noise from external power;
a rectifier to convert alternating current (AC) to direct current (DC) and having
a primary-side converting AC to a primary-side rectifier current;
a secondary-side receiving the primary-side rectifier current and converting the primary-side rectifier current to DC through a secondary-side rectifier, the secondary rectifier current being converted to output DC current by a FLYBACK converter that maintains and supplies power with stable current and voltage; and
a pulse width modulation (PWM) controller controlling the output DC current.

2. The LED light-emitting device as claimed in claim 1, wherein the flexible substrate is multiple modules that connect to each other.

3. The LED light-emitting device as claimed in claim 1, wherein the flexible substrate has at least one groove assembly comprising
a groove being formed in the outer surface of the flexible substrate and having two outer sidewalls perpendicular to the outer surface; and
a longitudinal plug being mounted in the groove, being slightly narrower than the groove and forming two corresponding gaps.

4. The LED light-emitting device as claimed in claim 1, wherein the flexible substrate has at least one pair of grooves comprising two narrow grooves being formed in the outer surface of the flexible substrate and having two outer sidewalls perpendicular to the outer surface.

5. The LED light-emitting device as claimed in claim 1, wherein the substrate further comprises a stiff substrate being mounted on the inside surface of the flexible substrate.

6. The LED light-emitting device as claimed in claim 1, wherein the flexible substrate further comprises a waterproof coating being mounted on the outer surface of the flexible substrate over the at least one pair of conductors.

7. The LED light-emitting device as claimed in claim 1, wherein the flexible substrate is foamed plastic.

8. The LED light-emitting device as claimed in claim 1, wherein the flexible substrate is rubber.

9. The LED light-emitting device as claimed in claim 1, wherein the flexible substrate is high-density foam.

10. The LED light-emitting device as claimed in claim 1, wherein the conductors are mounted on the outer surface of the flexible substrate.

11. The LED light-emitting device as claimed in claim 3, wherein the conductors are mounted respectively on the outer sidewalls of each groove assembly.

12. The LED light-emitting device as claimed in claim 3, wherein the groove is straight.

13. The LED light-emitting device as claimed in claim 3, wherein the groove is curved.

14. The LED light-emitting device as claimed in claim 4, wherein the conductors are mounted respectively on the outer sidewalls of each pair of narrow grooves.

15. The LED light-emitting device as claimed in claim 4, wherein the narrow grooves are straight.

16. The LED light-emitting device as claimed in claim 4, wherein the narrow grooves are curved.

17. The LED light-emitting device as claimed in claim 6, wherein the waterproof coating is an acrylic sheet mounted on the outer surface of the flexible substrate over the at least one pair of through holes that align respectively with all or part of the conductors.

18. The LED light-emitting device as claimed in claim 6, wherein the waterproof coating is a gel-like encapsulant and mounted on the outer surface of the flexible substrate over the conductors.
